(19) United States
(12) Patent Application Publication
(10) Pub. No.: US 2018/0327262 A1
(43) Pub. Date: Nov. 15, 2018

(54) METHOD AND APPARATUS FOR PRODUCING SYNTHESIS GAS

(71) Applicant: McMaster University, Hamilton (CA)

(72) Inventors: Thomas A. Adams, II, Dundas (CA); Jaffer H. Ghouse, Hamilton (CA)

(73) Assignee: McMaster University, Hamilton (CA)

(21) Appl. No.: 16/045,296

(22) Filed: Jul. 25, 2018

Related U.S. Application Data
(63) Continuation of application No. 15/091,773, filed on Apr. 6, 2016, now abandoned.
(60) Provisional application No. 62/143,280, filed on Apr. 6, 2015.

(51) Int. Cl. C01B 3/48; C01B 3/38

(52) U.S. Cl. CPC C01B 3/48; C01B 2203/062; C01B 3/384; C01B 2203/0805; C01B 2203/0233

(57) ABSTRACT

A method of producing synthesis gas includes directing a first flow of hot synthesis gas through a first conduit, and directing a second flow of feed gas through at least one second conduit. The second conduit contains a reforming catalyst. The feed gas includes a mixture of steam and a hydrocarbon gas. The second conduit has an outer surface in contact with the hot synthesis gas. Heat from the hot synthesis gas is transferred across the second conduit to the feed gas thereby heating the feed gas and cooling the hot synthesis gas. The heated feed gas contacts the reforming catalyst and undergoes a reforming reaction that produces a third flow of synthesis gas.

### CROSS-REFERENCE TO RELATED PATENT APPLICATIONS

The application is a continuation of U.S. patent application Ser. No. 15/091,773, filed Apr. 6, 2016 entitled “Method and Apparatus for Producing Synthesis Gas”, which claims the benefit of U.S. Provisional Application No. 62/143,280, filed on Apr. 6, 2015 entitled “Hybrid Radiant Syngas Cooler and Steam Methane Reformer”. The complete disclosures of Ser. Nos. 15/091,773 and 62/143,280 are incorporated herein by reference.

### FIELD

This disclosure relates to the field of methods and apparatus for producing synthesis gas.

### INTRODUCTION

Gasification and steam methane reforming (SMR) are two methods of producing synthesis gas. Gasification involves heating carbon-based materials, such as fossil fuels (e.g. coal) or organics (e.g. biomass) at very high temperatures in the presence of a controlled amount of oxygen or steam, to convert the carbon-based materials to carbon monoxide, hydrogen and carbon dioxide. Three common types of gasifiers include: fixed bed, fluidized bed, and entrained flow gasifiers. Such gasifiers are used in the chemical and petrochemical industry for synthetic fuel production, petroleum refining, methanol production, dimethyl ether production, and the production of other major commodity chemicals.

Gasification produces high temperature synthesis gas that requires post-production cooling. Two common synthesis gas coolers include radiant coolers that take heat from high pressure steam generated within tubes, and quench coolers that directly quench hot output gases with water. However, synthesis gas coolers are commonly large and expensive pieces of equipment that are prone to fouling and difficult to maintain. The efficiency and cost effectiveness of synthesis gas coolers remains a barrier to their broad market adoption.

Steam methane reforming (SMR) is an endothermic process in which a heated catalytic reaction converts steam and lighter hydrocarbons such as methane or biogas into hydrogen and carbon monoxide. In conventional SMR designs, a furnace transfers a substantial part of the heat to the feed gases.

### SUMMARY

In one aspect, a method of producing synthesis gas is disclosed. The method may comprise directing a first flow of hot synthesis gas through a first conduit; directing a second flow of feed gas through at least one second conduit, the second conduit containing a reforming catalyst, the feed gas comprising a mixture of steam and a hydrocarbon gas, and the second conduit having an outer surface in contact with the hot synthesis gas; and transferring heat from the hot synthesis gas across the second conduit to the feed gas thereby heating the feed gas and cooling the hot synthesis gas, the heated feed gas contacting the reforming catalyst and undergoing a reforming reaction that produces a third flow of synthesis gas.

In another aspect, an apparatus for producing synthesis gas is disclosed. The apparatus may comprise a first conduit defining a gas flow path; and at least one second conduit extending interior to the first conduit in the gas flow path, the second conduit containing a reforming catalyst.

### DRAWINGS

FIG. 1 is a schematic of a system for the production and consumption of synthesis gas, in accordance with at least one embodiment;

FIG. 2 is a cross-sectional view of an apparatus for producing synthesis gas, in accordance with at least one embodiment;

FIG. 3 is a cross-sectional view taken along line 3-3 in FIG. 2; and

FIG. 4 is a cross-sectional view of an apparatus for producing synthesis gas, in accordance with another embodiment.

### DESCRIPTION OF VARIOUS EMBODIMENTS

Numerous embodiments are described in this application, and are presented for illustrative purposes only. The described embodiments are not intended to be limiting in any sense. The invention is widely applicable to numerous embodiments, as is readily apparent from the disclosure herein. Those skilled in the art will recognize that the present invention may be practiced with modification and alteration without departing from the teachings disclosed herein. Although particular features of the present invention may be described with reference to one or more particular embodiments or figures, it should be understood that such features are not limited to usage in the one or more particular embodiments or figures with reference to which they are described.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

As used herein and in the claims, two or more parts are said to be “coupled”, “connected”, “attached”, or “fastened” where the parts are joined or operate together either directly or indirectly (i.e., through one or more intermediate parts), so long as a link occurs. As used herein and in the claims, two or more parts are said to be “directly coupled”, “directly connected”, “directly attached”, or “directly fastened” where the parts are connected in physical contact with each other. As used herein, two or more parts are said to be “rigidly coupled”, “rigidly connected”, “rigidly attached”, or “rigidly fastened” where the parts are coupled so as to move as one while maintaining a constant orientation relative to each other. None of the terms “coupled”, “connected”, “attached”, and “fastened” distinguish the manner in which two or more parts are joined together.

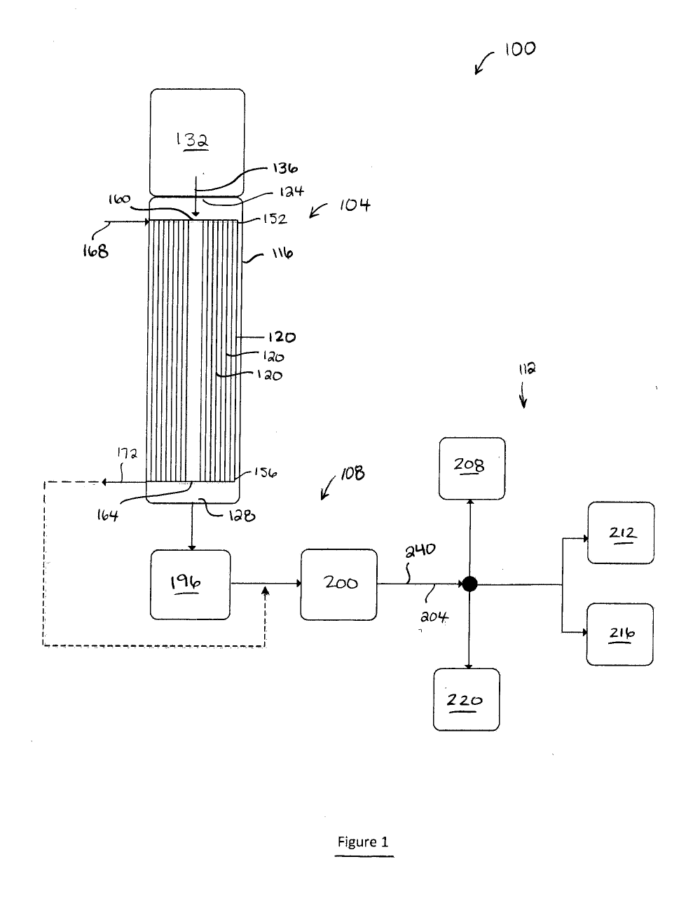

Referring to FIG. 1, a schematic illustration of a system 100 for the production and consumption of synthesis gas is shown, in accordance with at least one embodiment.

As shown, system 100 includes an apparatus 104 for producing synthesis gas, post-production gas treatments 108, and synthesis gas consuming processes 112.

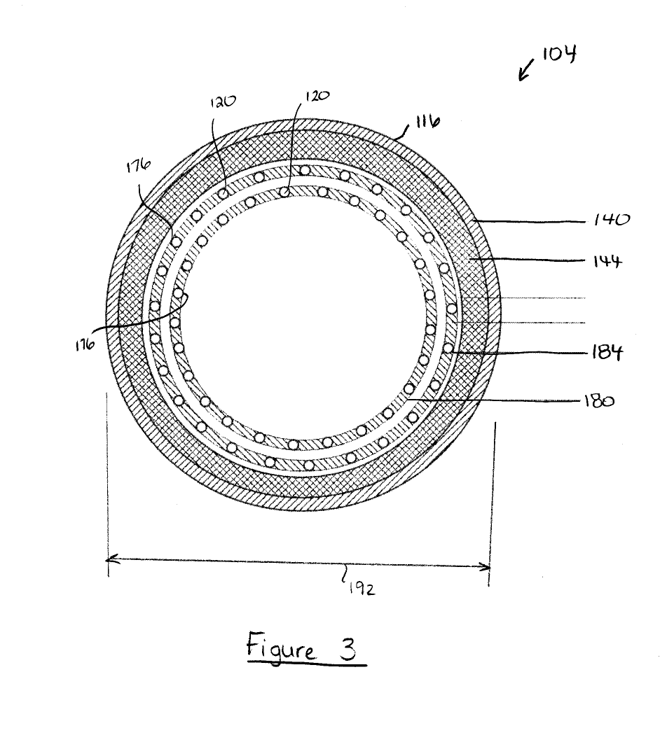

Referring now to FIGS. 1-3, apparatus 104 includes a first conduit 116, and one or more second conduits 120. The first conduit 116 has a first conduit inlet 124 and a first conduit outlet 128. As shown, first conduit inlet 124 may be axially spaced apart from first conduit outlet 128. First conduit inlet 124 receives hot synthesis gas produced by gasification. For example, FIG. 1 shows a gasifier 132 positioned upstream of first conduit inlet 124. In some embodiments, apparatus 104 may include gasifier 132. Gasifier 132 may be any device suitable for performing gasification to produce synthesis gas. Examples include fixed bed gasifiers, fluidized bed gasifiers, and entrained flow gasifiers. Alternatively, apparatus 104 may not include a gasifier, and instead apparatus 104 may be configured to connect downstream of a gasifier.

Gasification produces hot synthesis gases 136. The synthesis gases 136 may have an initial temperature of 1650 K or more upon production. To be workable in downstream applications, the hot synthesis gases 136 must be cooled, preferably below 473 K. For example, gas conduits such as first conduit 116 commonly have design specifications setting an upper temperature limit of 575K or less. In the illustrated embodiment, first conduit 116 is shown including a first conduit casing 140 that is thermally insulated from the flow of hot synthesis gas 136 inside by a refractory inner lining 144. First conduit casing 140 and refractory inner lining 144 may be made of any materials suitable for transporting hot synthesis gases 136. For example, first conduit casing 140 may be made of metal and refractory inner lining 144 may be made of a refractory material such as one or more layers of chrome brick refractory.

Still referring to FIGS. 1-3, second conduits 120 may extend inside first conduit 116. For example, second conduits 120 may extend along at least a portion of first conduit axial length 148. As shown, each second conduit 120 may include an inlet 152 and an outlet 156. In the illustrated example, second conduit inlet 152 is axially spaced apart from second conduit outlet 156. Second conduit inlets 152 and second conduit outlets 156 may be positioned inside or outside of first conduit 116. In the example shown, an upstream manifold 160 positioned inside first conduit 116 is connected to second conduit inlets 152, and a downstream manifold 164 positioned inside first conduit 116 is connected to second conduit outlets 156. Alternatively, one or both of upstream and downstream manifolds 160 and 164 may be positioned outside of first conduit 116. In some embodiments, apparatus 104 may not have one or both of upstream and downstream manifolds 160 and 164. For example, there may be only one second conduit 120 (so that the feed gas and output gas flows may not require dividing or consolidation), the second conduits 120 may receive feed gas from different sources, or the second conduits 120 may deliver separate output gas flows.

Each second conduit 120 contains reforming catalyst 166 between second conduit inlet 152 and second conduit outlet 156, in a section of second conduit 120 positioned within first conduit 116. In use, a flow of feed gas 168 enters second conduits 120 through second conduit inlets 152 and flows towards second conduit outlets 156 across reforming catalyst 166. The reforming catalyst 166 and heat promote feed gas 168 to undergo a reforming reaction that produces a synthesis gas flow 172. The feed gas 168 includes a mixture of steam and a hydrocarbon gas, such as methane or natural gas for example. The synthesis gas flow 172 may include a mixture of hydrogen, carbon monoxide, carbon dioxide, and possibly other gas components such as natural gas, methane, and/or other hydrocarbon gases, steam, or nitrogen.

The reforming reaction that produces synthesis gas flow 172 from feed gas flow 168 is endothermic, and therefore requires heat input. In general, the reforming reaction requires raising the feed gas flow 168 to at least 1000 K for a satisfactory rate of synthesis gas production. Preferably, feed gas flow 168 is heated to at least 1173 K. In the illustrated embodiment, second conduits 120 have an outer surface 176 in contact with the flow 136 of hot synthesis gas inside first conduit 116. This allows heat from the hot synthesis gas 136 to transfer across the second conduits 120 into the feed gas 168, thereby raising the temperature of the feed gas 168 and lowering the temperature of the hot synthesis gas 136. This can reduce or eliminate the need for equipment to cool hot synthesis gas 136, and can reduce or eliminate the need for equipment to heat feed gas 168, which can lead to savings in the form of reduced capital, operating, and maintenance expenses.

The first and second conduits 116 and 120 can have any configuration suitable to promote an efficient exchange of heat from the hot synthesis gas flow 136 in first conduit 116 to the feed gas flow 168 in second conduits 120. In the illustrated example, second conduits 120 extend in length along first conduit axial length 148. This provides feed gas flow 168 in second conduits 120 with continuous exposure to the heat of hot synthesis gas flow 136 in first conduit 116. For example, second conduits 120 may extend in parallel with first conduit 116 as shown, or take a more tortuous path inside first conduit 116 to increase the surface area of second conduit outer surface 176 which is exposed to hot synthesis gas flow 136.

In the illustrated example, first conduit inlet 124 and second conduit inlets 152 are proximate one another and axially spaced apart from first conduit outlet 128 and second conduit outlets 156. This provides apparatus 104 with a co-current flow configuration for synthesis gas flow 136 and feed gas flow 168. In alternative embodiments, the direction of the flow of gases in first conduit 116 may be opposite to second conduit 120. For example, first conduit inlet and outlet 124 and 128 may be reversed to provide a counter-current flow configuration.

In some cases, a co-current flow configuration may provide less efficient heat transfer than a counter-current flow configuration (all else being equal), but also produce lower second conduit wall temperatures which may be desirable in some applications. Of course, longer first and second conduit lengths 148 and 188 may compensate for the reduced heat transfer efficiency. On the other hand, a counter-current flow configuration may provide greater heat transfer efficiency than the co-current flow configuration, which may result in greater cooling to synthesis gas flow 136 and an increased reforming reaction rate. Furthermore, in the counter-current flow configuration, the feed gas 168 may experience less temperature gradient, which may allow greater processing rates of feed gas 168.

Apparatus 104 may include one second conduit 120 or a plurality of second conduits 120 (e.g. 5-100 second conduits 120). In the illustrated example, apparatus 104 includes 50 second conduits 120. A plurality of second conduits 120 may increase the second conduit outer surface 176 exposed to synthesis gas flow 136 for improved heat transfer efficiency. Where apparatus 104 includes a plurality of second conduits 120, the second conduits 120 may be spaced apart from each other and distributed inside first conduit 116 as shown. This can promote better heat transfer efficiency by providing pathways for synthesis gas 136 to flow between second conduits 120. For example, second conduits 120 may be arranged in one or more rows or rings. In the illustrated example, second conduits 120 are arranged in two concentric rings 180 and 184 spaced inwardly of first conduit refractory inner lining 144. The inner ring 180 of second conduits 120 may be staggered from the outer ring 184 of second conduits 120 to promote greater spacing between second conduits 120. Preferably, second conduits 120 are spaced apart from each other by a center to center distance of at least 1.5 times the diameter of the second conduits 120, such as 1.5 to 2 times the diameter of the second conduit 120. Further, a distance from the center of second conduits 120 of outer ring 184 to first conduit refractory inner lining 144 may be at least 1.5 times the diameter of the second conduits 120.

First and second conduits 116 and 120 may have any length 148 and 188 suitable to promote heat transfer from synthesis gas flow 136 to feed gas 168 and to allow for the synthesis reaction of feed gas 168. In some example, lengths 148 and 188 may be 10 m to 30 m. Shorter lengths may provide less heat transfer, and produce less synthesis gas 172 from feed gas 168, but may beneficially produce less pressure drop across the reforming catalyst 166 in second conduits 120.

First conduit 116 may have any diameter 192 suitable for carrying synthesis gas flow 136 and containing second conduits 120. For example, first conduit 116 may have a diameter 192 of 2.5 m to 4.5 m. A greater first conduit diameter 192 may support a greater synthesis gas flow 136 and a greater capacity for second conduits 120 for a higher overall synthesis gas production rate.

Referring to FIG. 1, system 100 may include one or more gas treatment stages 108 downstream of apparatus 104. In the illustrated example, downstream gas treatments 108 include a cooling stage 196 and an acid treatment stage 200. Cooling stage 196 may be provided to further reduce the temperature of synthesis gas flow 136 in preparation for downstream consumption (e.g. to 473 K). Cooling stage 196 may include, for example a synthesis gas quench cooler. It will be appreciated, however, that any equipment provided at cooling stage may be smaller or operated slower than the cooling equipment that would be required to cool synthesis gas flow 136 at the temperature it exits gasifier 132. In alternative embodiments, system 100 may not include a cooling stage 196. For example, synthesis gas flow 136 may be sufficiently cooled upon exiting apparatus 104.

Acid treatment stage 200 may be provided downstream of apparatus 104 (e.g. downstream of cooling stage 196 if present) to remove certain acidic gases that remain in one or both of synthesis gas flows 136 and 172. For example, acid treatment stage 200 may remove acidic hydrogen sulfide (H₂S) gas from the gas flows 136 and 172. In alternative embodiments, system 100 may not include an acid treatment stage.

Downstream of post-production gas treatments 108 (if any), the resulting synthesis gas flow 204 may be used by any one or more synthesis gas consuming processes. For example, synthesis gas 204 may be used for electricity production 208, for Fischer-Tropsch synthesis 212, for specialty chemicals production 216, and/or for hydrogen production 220.

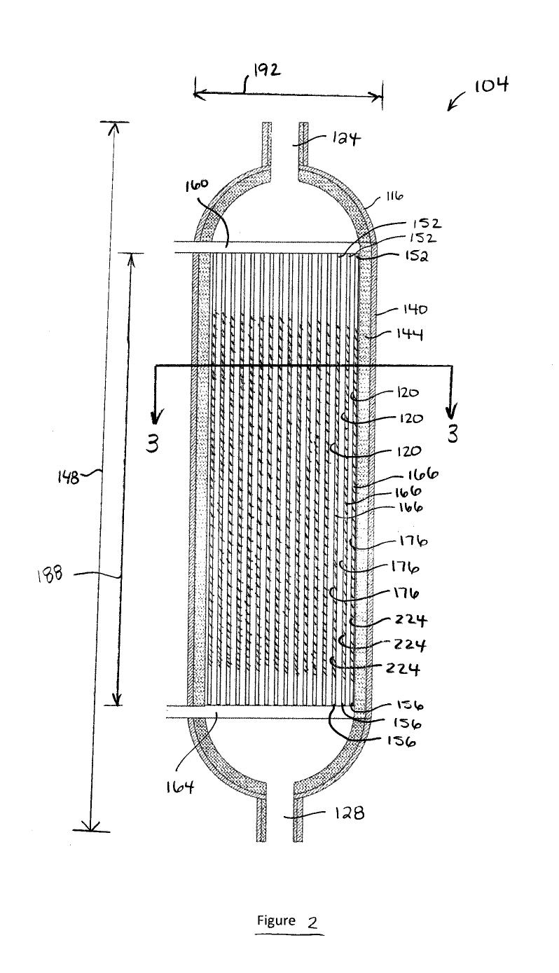

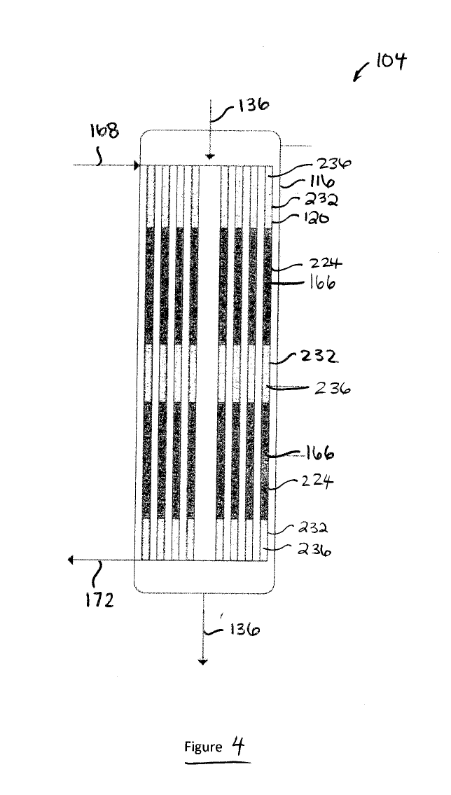

Referring to FIG. 2, reforming catalyst 166 may be packed into any one or more sections of a second conduit 120. In the illustrated embodiment, second conduit 120 contains reforming catalyst 166 packed into a singular continuous section 224. FIG. 4 shows another embodiment including a plurality of conduit sections 224 containing reforming catalyst 166, and which are spaced apart by conduit sections 232 which are free of reforming catalyst. For example, conduit sections 232 may be packed with inert packing material 236.

Referring to FIG. 1, synthesis gas is primarily a mixture of hydrogen, carbon monoxide, and carbon dioxide. In some contexts, the quality of the synthesis gas is measured by its molar ratio of H₂ to CO. Typically, the molar H₂:CO ratio of synthesis gas from gasifier 132 will be lower than synthesis gas 172 from SMR. For example, the molar H₂:CO ratio of synthesis gas 136 produced by gasification of coal or biomass usually ranges between 0.75 to 1.1. This can be too low for many applications, which may require downstream processing (e.g. in a water gas shift reactor) to increase the H₂ content in the synthesis gas. The synthesis gas 172 produced by SMR typically has a molar H₂:CO ratio of 3.5 to 8.5 which may be well above the minimum ratio requirement of some applications.

In some embodiments, at least a portion of gasification synthesis gas 136 is combined at least a portion of SMR synthesis gas 172 to produce a combined synthesis gas 204 having a target molar H₂:CO ratio. For example, metered quantities of synthesis gases 136 and 172 may be combined in a conduit 240 downstream of apparatus 104 to provide a synthesis gas 204 having a molar H₂:CO ratio of 2.1 for Fischer-Tropsch synthesis. This allows the hydrogen rich SMR synthesis gas 172 to supplement the hydrogen deficient gasification synthesis gas 136 to produce an application specific synthesis gas 204 without the downstream processing and equipment (e.g. water shift reactor) normally used to adapt the gasification synthesis gas 136. This can reduce capital, maintenance, and operating costs associated with the processing and equipment no longer required. In the context of apparatus 104, combining synthesis gases 136 and 172 is specially convenient, as the two gases are already co-processed in apparatus 104. Moreover, the proportion of each synthesis gas 136 and 172 in synthesis gas 204 can be readily varied to provide a selectively variable H₂:CO ratio for synthesis gas flow 204.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

### Items

Item 1. A method of producing synthesis gas, the method comprising:
directing a first flow of hot synthesis gas through a first conduit;
directing a second flow of feed gas through at least one second conduit, the second conduit containing a reforming catalyst, the feed gas comprising a mixture of steam and a hydrocarbon gas, and the second conduit having an outer surface in contact with the hot synthesis gas; and
transferring heat from the hot synthesis gas across the second conduit to the feed gas thereby heating the feed gas and cooling the hot synthesis gas, the heated feed gas contacting the reforming catalyst and undergoing a reforming reaction that produces a third flow of synthesis gas.
   Item 2. The method of item 1, further comprising:
producing the first flow of hot synthesis gas in a gasifier.
   Item 3. The method of item 2, wherein:
the gasifier is one of a fixed bed gasifier, a fluidized bed gasifier, and an entrained flow gasifier.
   Item 4. The method of any one of items 1-3, wherein:
the at least one second conduit extends interior to the first conduit.
   Item 5. The method of item 4, wherein:
the at least one second conduit comprises a plurality of second conduits.
   Item 6. The method of item 5, wherein:
within the first conduit, the plurality of second conduits are positioned spaced apart from each other.
   Item 7. The method of item 6, wherein:
each of the second conduits has a conduit diameter, and
within the first conduit, the plurality of second conduits are spaced apart from each other by a center to center distance of at least 1.5 times the conduit diameter.
   Item 8. The method of any one of items 1-7, further comprising:
mixing at least a portion of the first flow and at least a portion of the third flow into a fourth flow of synthesis gas.
   Item 9. The method of any one of items 1-8, wherein:
the first flow has a molar H₂:CO ratio greater than the third flow, and
the method further comprises forming a fourth flow of synthesis gas having a target molar H₂:CO ratio by mixing at least a portion of the first flow with at least a portion of the third flow.
   Item 10. An apparatus for producing synthesis gas, the apparatus comprising:
a first conduit defining a gas flow path; and
at least one second conduit extending interior to the first conduit in the gas flow path, the second conduit containing a reforming catalyst.
   Item 11. The apparatus of item 10, further comprising:
a gasifier having a synthesis gas outlet connected to the first conduit.
   Item 12. The apparatus of any one of items 10-11, wherein:
within the first conduit, the at least one second conduit is substantially co-axial with the first conduit.
   Item 13. The apparatus of any one of items 10-12, wherein:
the at least one second conduit contains first conduit portions containing the reforming catalyst, the first conduit portions spaced apart by a second conduit portion free of the reforming catalyst.
   Item 14. The apparatus of any one of items 10-12, wherein:
the second conduit contains the reforming catalyst distributed continuously along a length of the second conduit.
   Item 15. The apparatus of any one of items 10-12, wherein:
the at least one second conduit comprises a plurality of second conduits, each second conduit extending interior to the first conduit, and each second conduit containing reforming catalyst.
   Item 16. The apparatus of item 15, wherein:
within the first conduit, the plurality of second conduits are positioned spaced apart from each other.
   Item 17. The apparatus of any one of items 10-15, wherein:
each of the second conduits has a conduit diameter, and
within the first conduit, the plurality of second conduits are spaced apart from each other by a center to center distance of at least 1.5 times the conduit diameter.
   Item 18. The apparatus of any one of items 15-17, wherein:
the plurality of second conduits are arranged in at least two concentric rings.
   Item 19. The apparatus of any one of items 10-18, wherein:
the first conduit has a first conduit outlet,
the at least one second conduit has a second conduit outlet, and
the apparatus further comprises a third conduit having a third conduit inlet positioned downstream of the first conduit outlet and the second conduit outlet.
   Item 20. The apparatus of any one of items 10-19, wherein:
the first conduit comprises a casing and a refractory inner lining inside the casing, and
the at least one second conduit is positioned inwardly of the casing and the refractory inner lining.

1. A method of producing synthesis gas, the method comprising:
directing a first flow of hot synthesis gas through a first conduit;
directing a second flow of feed gas through at least one second conduit, the second conduit containing a reforming catalyst, the feed gas comprising a mixture of steam and a hydrocarbon gas, and the second conduit having an outer surface in contact with the hot synthesis gas; and
transferring heat from the hot synthesis gas across the second conduit to the feed gas thereby heating the feed gas and cooling the hot synthesis gas, the heated feed gas contacting the reforming catalyst and undergoing a reforming reaction that produces a third flow of synthesis gas.

2. The method of claim 1, further comprising:
producing the first flow of hot synthesis gas in a gasifier.

3. The method of claim 2, wherein:
the gasifier is one of a fixed bed gasifier, a fluidized bed gasifier, and an entrained flow gasifier.

4. The method of claim 1, wherein:
the at least one second conduit extends interior to the first conduit.

5. The method of claim 4, wherein:
the at least one second conduit comprises a plurality of second conduits.

6. The method of claim 5, wherein:
within the first conduit, the plurality of second conduits are positioned spaced apart from each other.

7. The method of claim 6, wherein:
each of the second conduits has a conduit diameter, and
within the first conduit, the plurality of second conduits are spaced apart from each other by a center to center distance of at least 1.5 times the conduit diameter.

8. The method of claim 1, further comprising:
mixing at least a portion of the first flow and at least a portion of the third flow into a fourth flow of synthesis gas.

9. The method of claim 1, wherein:
the first flow has a molar H₂:CO ratio greater than the third flow, and
the method further comprises forming a fourth flow of synthesis gas having a target molar H₂:CO ratio by mixing at least a portion of the first flow with at least a portion of the third flow.

10. An apparatus for producing synthesis gas, the apparatus comprising:
a first conduit defining a gas flow path; and
at least one second conduit extending interior to the first conduit in the gas flow path, the second conduit containing a reforming catalyst.

11. The apparatus of claim 10, further comprising:
a gasifier having a synthesis gas outlet connected to the first conduit.

12. The apparatus of claim 10, wherein:
within the first conduit, the at least one second conduit is substantially co-axial with the first conduit.

13. The apparatus of claim 10, wherein:
the at least one second conduit contains first conduit portions containing the reforming catalyst, the first conduit portions spaced apart by a second conduit portion free of the reforming catalyst.

14. The apparatus of claim 10, wherein:
the second conduit contains the reforming catalyst distributed continuously along a length of the second conduit.

15. The apparatus of claim 10, wherein:
the at least one second conduit comprises a plurality of second conduits, each second conduit extending interior to the first conduit, and each second conduit containing reforming catalyst.

16. The apparatus of claim 15, wherein:
within the first conduit, the plurality of second conduits are positioned spaced apart from each other.

17. The apparatus of claim 10, wherein:
each of the second conduits has a conduit diameter, and
within the first conduit, the plurality of second conduits are spaced apart from each other by a center to center distance of at least 1.5 times the conduit diameter.

18. The apparatus of claim 15, wherein:
the plurality of second conduits are arranged in at least two concentric rings.

19. The apparatus of claim 16, wherein:
the first conduit has a first conduit outlet,
the at least one second conduit has a second conduit outlet, and
the apparatus further comprises a third conduit having a third conduit inlet positioned downstream of the first conduit outlet and the second conduit outlet.

20. The apparatus of claim 10, wherein:
the first conduit comprises a casing and a refractory inner lining inside the casing, and
the at least one second conduit is positioned inwardly of the casing and the refractory inner lining.
